(19) United States
(12) Patent Application Publication
(10) Pub. No.: US 2021/0328298 A1
(43) Pub. Date: Oct. 21, 2021

(54) ENERGY STORAGE APPARATUS

(71) Applicants: Blue Energy Co., Ltd., Kyoto-shi (JP); Honda Motor Co., Ltd., Tokyo (JP)

(72) Inventors: Kenta YOSHIOKA, Kyoto-shi (JP); Kazuto YAMANE, Wako-shi (JP); Sachiko KATSUNO, Wako-shi (JP); Toshiyuki IKEUCHI, Wako-shi (JP)

(21) Appl. No.: 17/230,412

(22) Filed: Apr. 14, 2021

(30) Foreign Application Priority Data
Apr. 16, 2020 (JP) 2020-073279

(51) Int. Cl. H01M 50/209; H01M 50/249; H01M 50/264

(52) U.S. Cl. CPC H01M 50/209; H01M 50/264; H01M 50/249

(57) ABSTRACT

An energy storage apparatus includes: a plurality of energy storage devices arranged in a first direction; an adjacent member arranged between adjacent energy storage devices; and a device that functionally acts on the energy storage devices, in which the device is fixed to the adjacent member.

### FIELD

The present invention relates to an energy storage apparatus including a plurality of energy storage devices and adjacent members arranged between adjacent energy storage devices.

### BACKGROUND

Conventionally, a power supply device including battery cells formed by prismatic batteries has been known (see JP 2011-154985 A). This power supply device specifically includes: a battery block, in which the battery cells formed by the prismatic batteries are stacked in a state where cooling gaps are formed; and a forced air blowing mechanism that forcibly blows cooling gas to the battery cells of the battery block to cool them.

In the battery block, separators are each sandwiched between the stacked battery cells. This separator functions as a spacer for forming a cooling gap between the battery cells. As a result, the battery block, in which the battery cells are stacked with the separators interposed therebetween, is provided with the cooling gaps through which the cooling gas for cooling the battery cells passes between the battery cells. Further, the battery block is provided with a supply duct and discharge ducts, and a plurality of cooling gaps are communicated in parallel between the discharge ducts and the supply duct.

In this power supply device, the cooling gas forcibly blown from the supply duct to the discharge ducts by the forced air blowing mechanism is branched from the supply duct and blown to each cooling gap to cool the battery cells. Then, the cooling gas that has cooled the battery cells is collected in the discharge ducts and exhausted.

The power supply device is mounted on an electric vehicle such as a hybrid car or an electric automobile, for example. In such an electric vehicle, the number of components has increased due to improvement in performance and multi-functionality. Thus, saving a space for arranging the power supply device has been required.

In the power supply device, the battery block including the plurality of battery cells and the forced air blowing mechanism that cools the plurality of battery cells (i.e., that functionally acts on the plurality of battery cells) are individually fixed to, e.g., a structural frame of the electric vehicle. Thus, a fixing structure and a fixing member are required in the structural frame, and it is difficult to sufficiently save the arrangement space.

### SUMMARY

Therefore, an object of the present embodiment is to provide an energy storage apparatus capable of reducing the arrangement space.

According to an aspect of the present invention, there is provided an energy storage apparatus including: a plurality of energy storage devices arranged in a first direction; an adjacent member arranged between adjacent energy storage devices; and a device that functionally acts on the energy storage devices, in which the device is fixed to the adjacent member.

### BRIEF DESCRIPTION OF DRAWINGS

FIG. 1 is a perspective view of a device main body of an energy storage apparatus according to a present embodiment.

FIG. 2 is an exploded perspective view of a state in which a part of the device main body is omitted.

FIG. 3 is a perspective view of the energy storage apparatus.

FIG. 4 is an exploded perspective view of the energy storage apparatus.

FIG. 5 is a perspective view of an energy storage device included in the energy storage apparatus.

FIG. 6 is a perspective view of a first adjacent member included in the energy storage apparatus.

FIG. 7 is a perspective view of the first adjacent member.

### DESCRIPTION OF EMBODIMENTS

According to an aspect of the present invention, there is provided an energy storage apparatus including: a plurality of energy storage devices arranged in a first direction; an adjacent member arranged between adjacent energy storage devices; and a device that functionally acts on the energy storage devices, in which the device is fixed to the adjacent member.

According to such a configuration, the device is fixed to the energy storage apparatus by using the component (adjacent member) forming the energy storage apparatus. Thus, it is not necessary to provide a structure and a member for fixing the plurality of energy storage devices and the device in an apparatus in which the energy storage apparatus is arranged (mounted). As a result, the arrangement space of the energy storage apparatus is reduced.

The energy storage apparatus may further include a holding member that holds the plurality of energy storage devices and the adjacent member, and the holding member may include at least one of a fastening member that fastens the adjacent member to the holding member and a support portion that supports the adjacent member.

The device is fixed, so that the load on the adjacent member becomes large when vibration, impact, or the like is applied to the energy storage apparatus. However, according to such a configuration, since the adjacent member is at least fastened or supported by the holding member, the damage to the adjacent member and the like are suppressed when the vibration or the like is applied. Moreover, since the adjacent member is fastened to or supported by the holding member, the rigidity of the energy storage apparatus is improved, so that occurrence of resonance in the energy storage apparatus is also suppressed.

Further, in the energy storage apparatus, each of the of energy storage devices may include an external terminal projecting to one side in a second direction orthogonal to the first direction, and the device may be fixed to another side of the adjacent member in the second direction.

According to such a configuration, since the device is arranged on the side of the energy storage devices opposite to the side where the external terminals are arranged, a sufficient distance from the external terminals is secured, and a short circuit with the external terminals is more reliably suppressed. Moreover, the device is arranged on the side of the energy storage devices opposite to the side where the external terminals are arranged. Thus, in the arrangement of the device, the external terminals that project do not get in the way.

The energy storage apparatus may further include a connection component that functionally connects the plurality of energy storage devices and the device, and the device may be arranged at a central portion or a substantially central portion of the energy storage apparatus in the first direction.

According to such a configuration, the connection component can be arranged symmetrically or substantially symmetrically with respect to the central portion in the first direction. As a result, the weight balance and the like at the time of arrangement can be easily adjusted.

As descried above, according to an aspect of the present invention, it is possible to provide the energy storage apparatus capable of reducing the arrangement space.

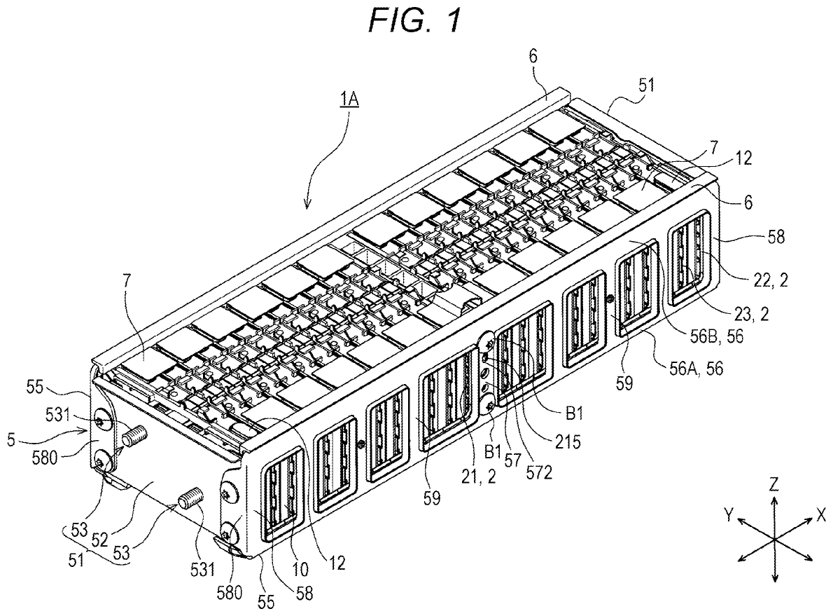

Hereinafter, an embodiment of the present invention will be described with reference to FIGS. 1 to 7. The names of the components (constituent elements) used in the present embodiment may differ from the names of the components (constituent elements) in the background technology.

As shown in FIGS. 1 to 4, an energy storage apparatus includes a device main body 1A including a plurality of energy storage devices 10 and a device 3 that functionally acts on the energy storage devices 10. The energy storage apparatus 1 also includes a connection component 4 that functionally connects the plurality of energy storage devices 10 and the device 3. In the present embodiment, “functionally connects” means connecting so that the function of the device 3 is exerted or acts on the plurality of energy storage devices 10.

The device main body 1A includes the plurality of energy storage devices 10 arranged in a predetermined direction (first direction), adjacent members 2 adjacent to the energy storage devices 10, and a holding member 5 that holds the plurality of energy storage devices 10 and the adjacent members 2. The device main body 1A of the present embodiment includes the plurality of energy storage devices 10 and the plurality of adjacent members 2, and the holding member 5 collectively holds the plurality of energy storage devices 10 and the plurality of adjacent members 2. Further, the device main body 1A also includes insulators 6 arranged between the energy storage devices 10 and the holding member 5, bus bars 7 that conductively connect different energy storage devices 10 to each other, and the like.

Each of the energy storage devices 10 is a primary battery, a secondary battery, a capacitor, or the like. The energy storage devices 10 of the present embodiment are non-aqueous electrolyte secondary batteries that can be charged and discharged. More specifically, the energy storage devices 10 are lithium ion secondary batteries that utilize electron transfer generated by movement of lithium ions.

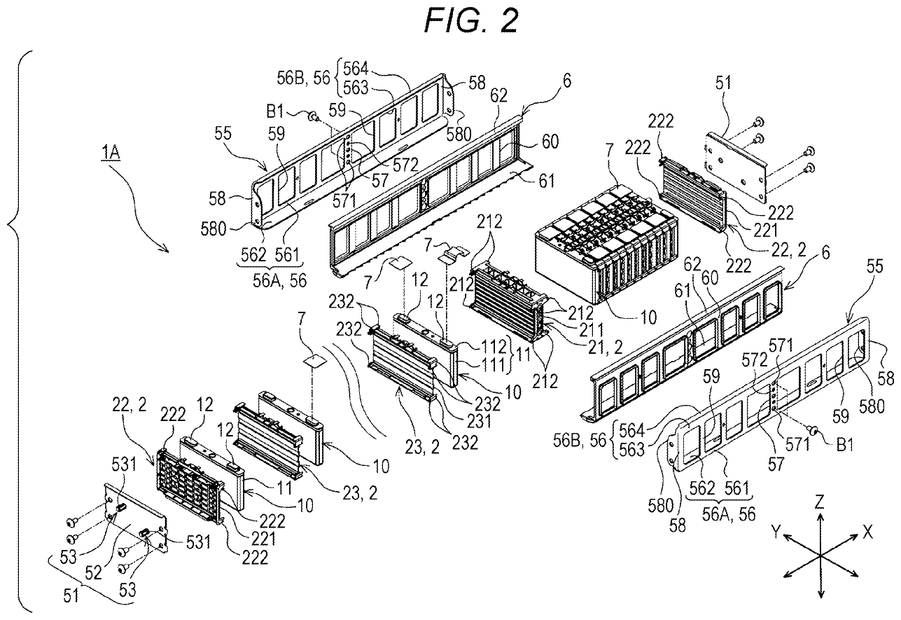

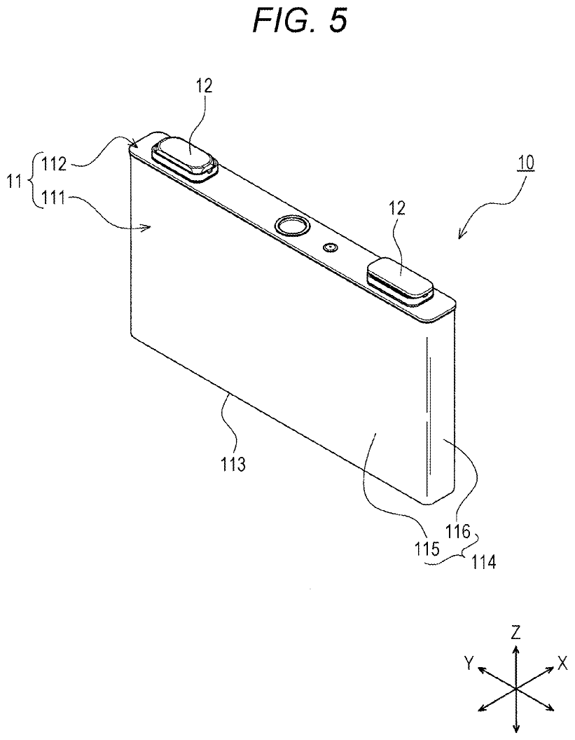

As shown in FIGS. 2 and 5, each of the energy storage devices 10 includes external terminals 12 projecting to one side in a direction (second direction) orthogonal to the predetermined direction. Specifically, each of the energy storage devices 10 includes an electrode body, a case 11 in which the electrode body is housed together with an electrolytic solution, the external terminals 12 which are at least partially exposed to the outside of the case 11, and a current collector that connects the electrode body and the external terminals 12.

In the electrode body, a positive electrode and a negative electrode are alternately layered via separators. Lithium ions move between the positive electrode and the negative electrode in this electrode body, so that the energy storage device 10 is charged and discharged.

The case 11 includes a case main body 111 having an opening, and a plate-shaped lid plate 112 that closes the opening of the case main body 111.

The case main body 111 includes a rectangular plate-shaped closing portion 113, and a tubular body portion (peripheral wall) 114 connected to the peripheral edge of the closing portion 113. The body portion 114 has a square tube shape, more specifically, a flat square tube shape. The body portion 114 includes a pair of long wall portions 115 extending from the long sides at the peripheral edge of the closing portion 113, and a pair of short wall portions 116 extending from the short sides at the peripheral edge of the closing portion 113. The short wall portions 116 each connect the corresponding end portions of the pair of long wall portions 115 to each other to form the square tubular body portion 114. The case 11 of the present embodiment has a flat rectangular parallelepiped shape, and the plurality of energy storage devices 10 are arranged in a state where the wide surfaces (long wall portions 115) of the cases 11 (case main bodies 111) face each other.

In the following, the direction in which the plurality of energy storage devices 10 are arranged (first direction) is defined as the X-axis of the Cartesian coordinate system, the direction in which the pair of short wall portions 116 face each other is defined as the Y-axis of the Cartesian coordinate system, and the direction in which the external terminals 12 project from the case 11 (second direction) is defined as the Z-axis of the Cartesian coordinate system.

Referring back to FIGS. 1 to 4, the adjacent member 2 is arranged between the energy storage devices 10 arranged in the X-axis direction or between the energy storage device 10 and a member arranged in the X-axis direction with respect to the energy storage device 10 (a part of the holding member 5 in the example of the present embodiment). The adjacent members 2 include a plurality of types of adjacent members. The adjacent members 2 of the present embodiment include a first adjacent member (adjacent member) 21 arranged between two adjacent energy storage devices 10 arranged at an intermediate position in the X-axis direction of the energy storage apparatus 1, second adjacent members 22 each adjacent to the energy storage device 10 present at the most end of the plurality of energy storage devices 10 arranged in the X-axis direction, and third adjacent members 23 each arranged between two adjacent energy storage devices 10 present between the first adjacent member 21 and the second adjacent member 22. The energy storage apparatus 1 of the present embodiment includes one first adjacent member 21. Further, the second adjacent members 22 are arranged on the outer sides of the energy storage devices 10 arranged at the most ends in the X-axis direction, respectively. That is, the energy storage apparatus 1 of the present embodiment includes a pair of second adjacent members 22. Further, the energy storage apparatus 1 of the present embodiment includes a plurality of third adjacent members 23. The first adjacent member 21 is not limited to one, and a plurality of first adjacent members 21 may be arranged.

The first adjacent member 21 is arranged at a central portion or a substantially central portion of the energy storage apparatus 1 in the X-axis direction. The first adjacent member 21 is arranged between two energy storage devices 10 arranged in the X-axis direction. Thus, a predetermined interval (creeping distance, etc.) is secured between the two energy storage devices 10 adjacent to each other with the first adjacent member 21 sandwiched in the X-axis direction. The first adjacent member 21 of the present embodiment is fastened (fixed) to the holding member 5.

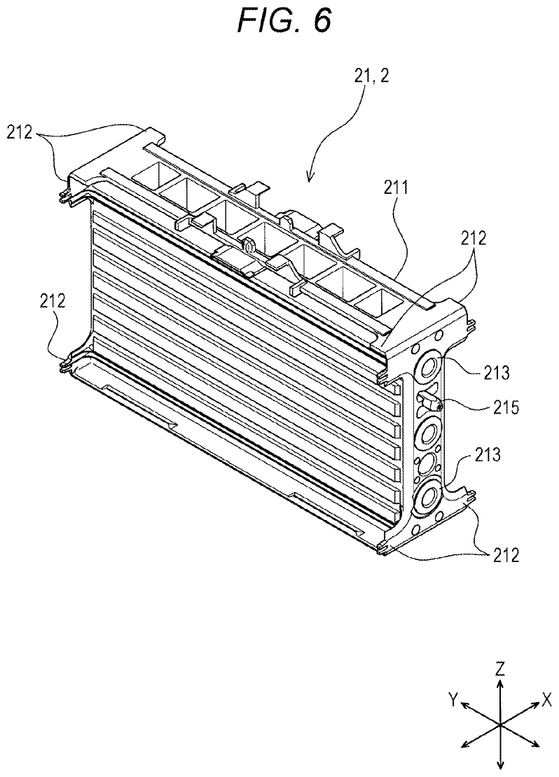

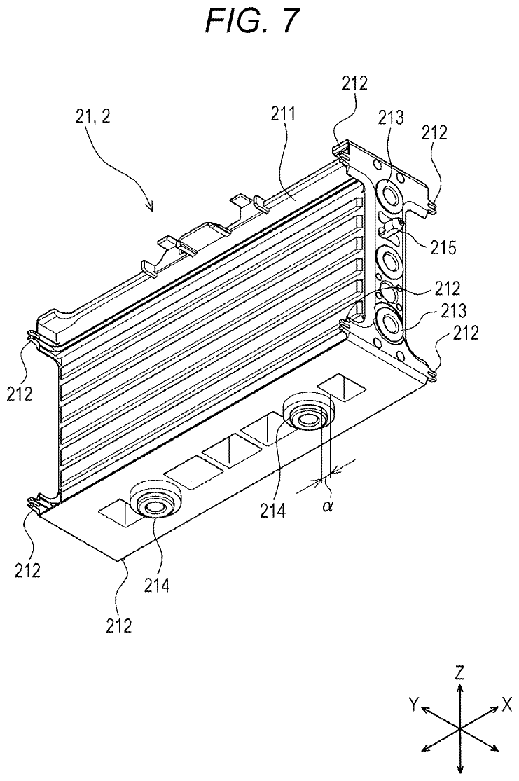

Specifically, as shown in FIGS. 6 and 7, the first adjacent member 21 includes a plate-shaped first main body portion 211 located between the two energy storage devices 10 adjacent to each other in the X-axis direction, and first regulating portions 212 that regulate movement of the energy storage devices 10 adjacent to the first main body portion 211 with respect to the first main body portion 211.

The first main body portion 211 has a rectangular contour corresponding to the energy storage device 10 (case 11) when viewed from the X-axis direction. The first main body portion 211 includes first fastened portions 213 for fixing the first main body portion 211 to the holding member 5, and second fastened portions 214 to which the device 3 is connected (fixed). Further, the first main body portion 211 includes shaft portions 215 that engage with the holding member 5. Further, the first main body portion 211 forms a flow path through which a fluid for temperature adjustment (air in the example of the present embodiment) passes between the first main body portion 211 and the energy storage device 10 adjacent in the X-axis direction. The first main body portion 211 of the present embodiment forms the flow path between the first main body portion 211 and each of the two energy storage devices 10 adjacent in the X-axis direction.

The first adjacent member 21 of the present embodiment is made of resin, and the first main body portion 211 is lightened in order to prevent shrinkage (see FIGS. 6 and 7). Further, in the first adjacent member 21 of the present embodiment, the dimension of the first main body portion 211 in the X-axis direction is larger than the dimensions of the portions of the second adjacent member 22 and the third adjacent member 23 which correspond to the first main body portion 211 in the X-axis direction.

The first fastened portions 213 are provided at the end portions of the first main body portion 211 in the Y-axis direction. The first fastened portions 213 of the present embodiment are provided at both end portions of the first main body portion 211 in the Y-axis direction, respectively. The first fastened portions 213 are each a portion into which a fastening member (bolt in the example of the present embodiment) B1 is screwed in a state of penetrating the holding member 5. In the energy storage apparatus 1, the first main body portion 211 (first adjacent member 21) and the holding member 5 are fastened (fixed) by screwing the bolts B1 into the first fastened portions 213. The first fastened portions 213 of the present embodiment are nuts (so-called insert nuts) embedded in the end portions of the first main body portion 211 in the Y-axis direction by insert molding.

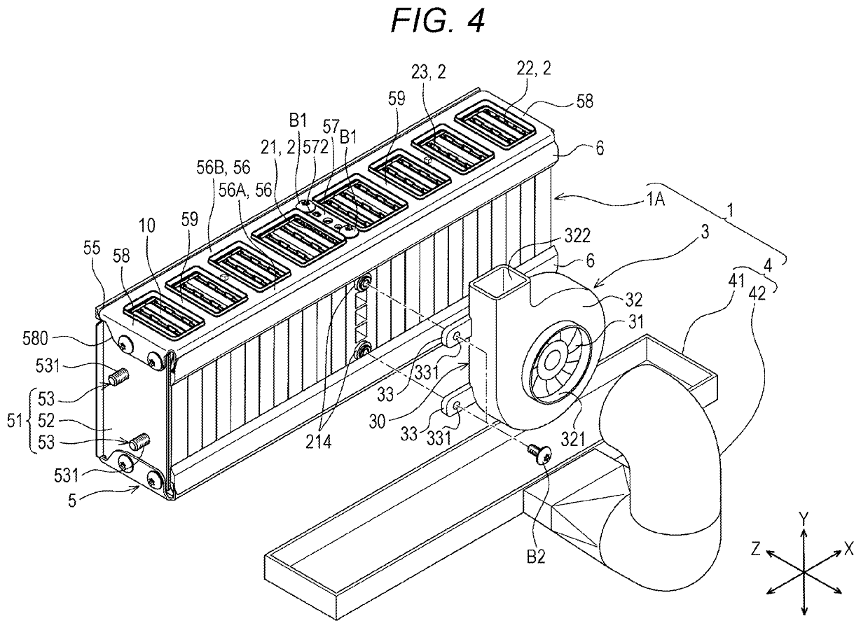

The second fastened portions 214 are provided at one end portion of the first main body portion 211 in the Z-axis direction (end portion of the energy storage device 10 opposite to the side where the external terminals 12 are provided). The second fastened portions 214 are each a portion into which a fastening member (bolt in the example of the present embodiment) B2 is screwed in a state of penetrating a part of the device 3. In the energy storage apparatus 1, the first main body portion 211 (first adjacent member 21) and the device 3 are fastened by screwing the bolts B2 into the second fastened portions 214. The second fastened portions 214 of the present embodiment are nuts (so-called insert nuts) embedded in one end portion of the first main body portion 211 in the Z-axis direction by insert molding (see FIGS. 4 and 7). The thickness a (see FIG. 7) of the resin around the second fastened portion (insert nut) 214 is set to a thickness in consideration of shrinkage. For example, specifically, the thickness a of the resin around the second fastened portion 214 is uniform at each position in the circumferential direction so as not to cause shrinkage.

Further, in the Z-axis direction, the end portion of one side (right side in FIG. 4) of the second fastened portion 214 is located on the inner side of the holding member 5 and the insulator 6 (the other side in the Z-axis direction: the left side in FIG. 4). That is, in the Z-axis direction, the second fastened portion 214 does not project from the outer surfaces of the holding member 5 and the insulator 6. As a result, when the device 3 is fixed to the first adjacent member 21, it is possible to prevent buffering between the second fastened portions 214 and the device 3.

The shaft portions 215 extend outward from the ends of the first main body portion 211 in the Y-axis direction and engage with the holding member 5. The shaft portions 215 of the present embodiment extend outward from both ends of the first main body portion 211 in the Y-axis direction, respectively. Specifically, the shaft portions 215 each extend in a columnar shape in the Y-axis direction from an intermediate position in the Z-axis direction at the end portion of the first main body portion 211 in the Y-axis direction, and are each inserted through a shaft-portion through hole 572 provided at a portion of the holding member 5 which corresponds to the shaft portion 215 (see FIG. 1).

The first regulating portions 212 extend from the first main body portion 211 in the X-axis direction, and regulate relative movement of the energy storage devices 10 (specifically, the cases 11) adjacent to the first main body portion 211 in the Y-Z plane (plane including the Y-axis and the Z-axis) direction with respect to the first main body portion 211 by abutting the energy storage devices 10 from the outer side in the Y-Z plane direction. The first regulating portions 212 of the present embodiment extend from the first main body portion 211 toward both sides in the X-axis direction, respectively.

Each of the pair of second adjacent members 22 has an insulating property, and is arranged between the energy storage device 10 and the holding member 5 (end member 51) adjacent to each other in the X-axis direction. A predetermined distance (creeping distance, etc.) is secured between the energy storage device 10 and the holding member 5 (end member 51) by the second adjacent member 22.

Specifically, the second adjacent member 22 includes a second main body portion 221 adjacent to the energy storage device 10 between the energy storage device 10 and the holding member 5, and second regulating portions 222 that regulate movement of the energy storage device 10 with respect to the second main body portion 221.

The second main body portion 221 is a portion facing the long wall portion 115 in the case 11 of the energy storage device 10 arranged at the end portion in the X-axis direction, and is a portion extending in the Y-Z plane direction. The second main body portion 221 of the present embodiment forms a flow path through which a fluid for temperature adjustment (air in the example of the present embodiment) passes between the second main body portion 221 and the energy storage device 10 adjacent in the X-axis direction.

The second regulating portions 222 extend from the second main body portion 221 in the X-axis direction, and regulate relative movement of the energy storage device 10 (specifically, the case 11) adjacent to the second main body portion 221 in the Y-Z plane direction with respect to the second main body portion 221 by abutting the energy storage device 10 from the outer side in the Y-Z plane direction. The second regulating portions 222 of the present embodiment extend from the second main body portion 221 toward one side in the X-axis direction (side on which the energy storage device 10 is arranged).

Each of the third adjacent members 23 has an insulating property, and is arranged between two energy storage devices 10 adjacent to each other in the X-axis direction. With the third adjacent member 23, a predetermined interval (creeping distance, etc.) is secured between the two energy storage devices 10 adjacent to each other with the third adjacent member 23 sandwiched in the X-axis direction.

Specifically, the third adjacent member 23 includes a plate-shaped third main body portion 231 located between the two energy storage devices 10 adjacent to each other in the X-axis direction, and third regulating portions 232 that regulate movement of the energy storage devices 10 adjacent to the third main body portion 231 with respect to the third main body portion 231.

The third main body portion 231 is a portion facing the long wall portions 115 of the cases 11 of the energy storage devices 10, and extends in the Y-Z plane direction. The third main body portion 231 forms a flow path through which a fluid for temperature adjustment (air in the example of the present embodiment) can flow between the third main body portion 231 and the energy storage device 10 adjacent in the X-axis direction. The third main body portion 231 of the present embodiment forms the flow path between the third main body portion 231 and each of the two energy storage devices 10 adjacent in the X-axis direction.

The third regulating portions 232 extend from the third main body portion 231 in the X-axis direction, and regulate relative movement of the energy storage devices 10 (specifically, the cases 11) adjacent to the third main body portion 231 in the Y-Z plane direction with respect to the third main body portion 231 by abutting the energy storage devices 10 from the outer side in the Y-Z plane direction. The third regulating portions 232 of the present embodiment extend from the third main body portion 231 toward both sides in the X-axis direction, respectively.

The holding member 5 collectively holds the plurality of energy storage devices 10 and the plurality of adjacent members 2 by surrounding the periphery of the plurality of energy storage devices 10 and the plurality of adjacent members 2. The holding member 5 is formed of a member having conductivity such as a metal. Further, the holding member 5 includes at least one of the bolts (fastening members) B1 that fasten the first adjacent member 21 to the holding member 5 and first extending portions (support portions) 562 that support the first adjacent member 21. The holding member 5 of the present embodiment includes both the bolts B1 and the first extending portions 562. Specifically, the holding member 5 includes the pair of end members 51 arranged on both sides of the plurality of energy storage devices 10 in the X-axis direction, coupling members 55 that couple the pair of end members 51, and the plurality of bolts B1 and B2.

Each of the pair of end members 51 is arranged so as to sandwich the second adjacent member 22 with the energy storage device 10 arranged at the end in the X-axis direction. Each of the pair of end members 51 includes a main body 52 extending along the second adjacent member 22 and bolt-shaped members 53 attached to the main body 52. The end member 51 of the present embodiment includes two bolt-shaped members 53.

Each of the two bolt-shaped members 53 includes a head portion and a shaft portion 531 extending from the head portion. The head portion is larger than the shaft portion 531 in the Y-Z plane direction. The shaft portion 531 is a male screw extending in the X-axis direction. The bolt-shaped members 53 are used to fix the energy storage apparatus 1 to an installation object when the energy storage apparatus 1 is mounted or installed. For example, when the energy storage apparatus 1 of the present embodiment is mounted on an automobile, the bolt-shaped members 53 are used to fix the energy storage apparatus 1 at the installation position of the automobile.

The pair of coupling members 55 are arranged on both sides of the plurality of energy storage devices 10 in the Y-axis direction, respectively. Each of these pair of coupling members 55 includes a pair of beam portions 56 extending in the X-axis direction and arranged at an interval in the Z-axis direction, a first coupling portion 57 that couples the pair of beam portions 56 to each other at an intermediate position in the X-axis direction (a position that overlaps the first adjacent member 21 when viewed from the Y-axis direction in the example of the present embodiment), and a pair of second coupling portions 58 that couple the end portions of the pair of beam portions 56 to each other. The coupling member 55 of the present embodiment also includes third coupling portions 59 that couple the pair of beam portions 56 between the first coupling portion 57 and each of the second coupling portions 58.

A beam portion (first beam portion) 56A on one side of the pair of beam portions 56 (closing portion 113 side of the case 11) includes a first main body 561 extending in the X-axis direction along the short wall portions 116 of the case main body 111, and a first extending portion (support portion) 562 extending from the first main body 561 along the lid plates 112 of the case 11 and extending in the X-axis direction. Further, a beam portion (second beam portion) 56B on the other side of the pair of beam portions 56 (lid plate 112 side of the case 11) includes a second main body 563 extending in the X-axis direction along the short wall portions 116 of the case main body 111, and a second extending portion 564 extending from the second main body 563 along the lid plates 112 of the case 11 and extending in the X-axis direction.

The first extending portion 562 is a portion having a plate shape extending in the Y-axis direction from the end edge of the first main body 561 on the closing portion 113 side and extending in the X-axis direction, that is, a plate shape along the closing portions 113 of the plurality of energy storage devices 10 arranged in the X-axis direction. The first extending portion 562 of the present embodiment has a rectangular shape that is long in the X-axis direction when viewed from the Z-axis direction. The first extending portion 562 of the present embodiment supports the first adjacent member 21 by abutting the first adjacent member 21 from the outside in the Z-axis direction. Specifically, the first extending portion 562 is in abutment against the first adjacent member 21 from the outside in the Z-axis direction via the insulator 6. The first extending portion 562 and the first main body 561 to which the first extending portion 562 is connected (that is, the first beam portion 56A) have an L-shaped cross sectional shape (cross sectional shape in the Y-Z plane direction), that is, a cross sectional shape in which the central portion is bent, and restrain the corner portions of the energy storage devices 10 on the closing portion 113 side (corner portions each formed by the closing portion 113 and the short wall portion 116 in each energy storage device 10) from the outside in the Y-Z plane direction.

The second extending portion 564 is a portion having a plate shape extending in the Y-axis direction from the end edge of the second main body 563 on the lid plate 112 side and extending in the X-axis direction, that is, a plate shape along the lid plates 112 of the plurality of energy storage devices 10 arranged in the X-axis direction. Further, the dimension of the second extending portion 564 in the Y-axis direction is smaller than the dimension of the first extending portion 562 in the Y-axis direction. The second extending portion 564 and the second main body 563 to which the second extending portion 564 is connected (that is, the second beam portion 56B) have an L-shaped cross sectional shape (cross sectional shape in the Y-Z plane direction), that is, a cross sectional shape in which the central portion is bent, and restrain the corner portions of the energy storage devices 10 on the lid plate 112 side (corner portions each formed by the lid plate 112 and the short wall portion 116 in each energy storage device 10) from the outside in the Y-Z plane direction.

The first coupling portion 57 extends in the Z-axis direction and has through holes 571 and 572 that penetrate in the thickness direction (Y-axis direction) at positions corresponding to the first fastened portions 213 and the shaft portion 215 of the first adjacent member 21 (specifically, overlapping positions when viewed from the Y-axis direction). The bolts B1 are inserted through the through holes (fastening through holes) 571, and the bolts B1 are screwed into the first fastened portions 213 of the first adjacent member 21. As a result, the coupling member 55 and the first adjacent member 21 are fastened (coupled). Further, the shaft portion 215 of the first adjacent member 21 is inserted through the through hole (shaft-portion through hole) 572.

Each of the pair of second coupling portions 58 extends in the Z-axis direction at a position overlapping the end member 51 when viewed from the Y-axis direction. Each of the pair of second coupling portions 58 includes a portion (connecting piece) 580 connected to the end member 51.

The third coupling portions 59 extend in the Z-axis direction at positions overlapping the energy storage devices 10 when viewed from the Y-axis direction. A plurality of third coupling portions 59 of the present embodiment are arranged between the first coupling portion 57 and each of the second coupling portions 58.

The insulator 6 has an insulating property and is arranged between the coupling member 55 and the plurality of energy storage devices 10. The insulator 6 covers a region of the coupling member 55 facing at least the plurality of energy storage devices 10. As a result, the insulator 6 insulates between the coupling member 55 and the plurality of energy storage devices 10 arranged in the X-axis direction. Specifically, the insulator 6 includes a covering-portion main body 60 that covers the first and second main bodies 561 and 563 and the first to third coupling portions 57 to 59, a first portion 61 that covers the first extending portion 562, and a second portion 62 that covers the second extending portion 564.

The device 3 is fixed to the first adjacent member 21. The device 3 of the present embodiment is a fan that supplies a fluid for temperature adjustment to the plurality of energy storage devices 10.

The fan (device) 3 includes a blower main body 30 including an impeller 31, a drive unit that drives the impeller 31, and a casing 32 having the impeller 31 inside and defining an intake port 321 and a discharge port 322, and fixing portions 33 for fixing the blower main body 30 to the first adjacent member 21. In this fan 3, air is taken in from the intake port 321 by rotating the impeller 31 in the casing 32, and the air sucked into the casing 32 from the intake port 321 is discharged from the discharge port 322.

The fixing portions 33 are portions extending from the casing 32 and each have a through hole 331. The fan 3 is fixed to the first adjacent member 21 by screwing the bolts B2, in a state of being inserted through the through holes 331, into the second fastened portions 214 of the first adjacent member 21.

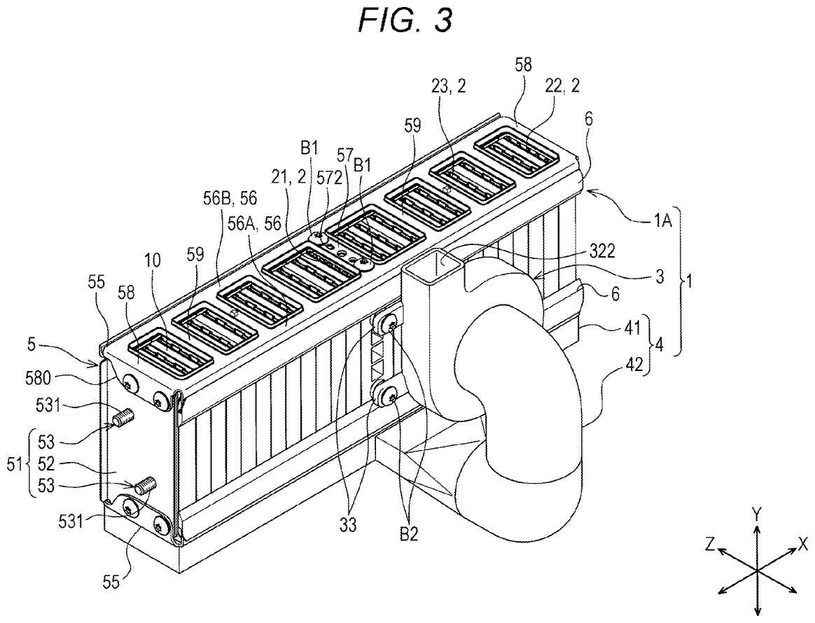

The connection component 4 is a duct including a cover portion 41 that covers the coupling member 55 on one side in the Y-axis direction (lower side in FIG. 3), and a pipe portion 42 that connects the cover portion 41 and the intake port 321 of the fan 3. The cover portion 41 has a shape corresponding to the coupling member 55, for example, a rectangular box shape long in the X-axis direction when viewed from the Y-axis direction. The pipe portion 42 allows communication between the region surrounded by the cover portion 41 and the intake port 321 of the fan 3. The pipe portion 42 of the present embodiment connects the central portion or substantially the central portion of the cover portion 41 in the X-axis direction and the intake port 321 of the fan 3.

In this way, the intake port 321 of the fan 3 is connected to the coupling member 55 on one side in the Y-axis direction by the duct 4. Therefore, when the fan 3 is driven (takes in air from the intake port 321), the air is sucked into each flow path (each flow path formed between the energy storage device 10 and the adjacent member 2) from the coupling member 55 on the other side in the Y-axis direction (upper side in FIG. 3) of the energy storage apparatus 1 (specifically, the opening portions formed in the coupling member 55 (openings surrounded by the beam portions 56, the first coupling portion 57, the second coupling portions 58, the third coupling portions 59, and the like)). As the air flows through the flow path, heat exchange between the air and the energy storage device 10 is performed, and whereby the temperature of the energy storage device 10 is adjusted. The air that has been subjected to heat exchange with the energy storage device 10 is taken into the fan 3 through the duct 4 from the coupling member 55 on one side (specifically, the opening portions formed in the coupling member 55), and is discharged to the outside through the discharge port 322 of the fan 3.

The bus bar 7 is a plate-shaped member having conductivity such as metal. The bus bar 7 conducts the external terminals 12 of the energy storage devices 10 to each other. A plurality of bus bars 7 (a number corresponding to the plurality of energy storage devices 10) are provided in the energy storage apparatus 1. The plurality of bus bars 7 of the present embodiment connect (conduct) all of the plurality of energy storage devices 10 included in the energy storage apparatus 1 in series.

According to the above energy storage apparatus 1, the fan (device) 3 is fixed to the energy storage apparatus 1 by using the component (first adjacent member 21) forming the energy storage apparatus 1. Thus, it is not necessary to provide a structure and a member for fixing the device main body 1A (plurality of energy storage devices 10) and the fan 3 in a device in which the energy storage apparatus 1 is arranged (mounted). As a result, the arrangement space of the energy storage apparatus 1 is reduced.

The fan 3 is fixed to the first adjacent member 21 as in the energy storage apparatus 1 of the present embodiment, so that the load on the first adjacent member 21 becomes large when vibration, impact, or the like is applied to the energy storage apparatus 1. However, in the energy storage apparatus 1 of the present embodiment, since the first adjacent member 21 is fastened to the holding member 5 and the first adjacent member 21 is supported by the first extending portions 562, the damage to the first adjacent member 21 and the like are suppressed when the vibration or the like is applied. Moreover, since the first adjacent member 21 is fastened to the holding member 5 and supported by the first extending portions 562, the rigidity of the energy storage apparatus 1 is improved, so that occurrence of resonance in the energy storage apparatus 1 is also suppressed. Further, since the first adjacent member 21 is supported by the first extending portions 562, even if the bolts B1 are loosened, displacement of the first adjacent member 21 is suppressed.

Further, in the energy storage apparatus 1 of the present embodiment, the fan 3 is fixed to the side opposite to the side where the external terminals 12 of the first adjacent member 21 are arranged in the Z-axis direction. As a result, a sufficient distance from the external terminals 12 of each energy storage device 10 is secured, and a short circuit between the fan 3 and the external terminals 12 is more reliably suppressed. Moreover, the fan 3 is arranged on the side of the energy storage devices 10 opposite to the side where the external terminals 12 are arranged. Thus, in the arrangement of the fan 3, the external terminals 12 projecting from the cases 11 and members such as the bus bars 7 and electric wires connected to the external terminals 12 do not get in the way.

Further, in the energy storage apparatus 1 of the present embodiment, the first adjacent member 21 is arranged at the central portion in the X-axis direction, that is, the fan 3 fixed to the first adjacent member 21 is arranged at the central portion or the substantially central portion in the X-axis direction. Accordingly, the duct 4 can be arranged symmetrically or substantially symmetrically with respect to the central portion in the X-axis direction, and as a result, the weight balance and the like at the time of arrangement can be easily adjusted.

Moreover, in the energy storage apparatus 1 of the present embodiment, since the pipe portion 42 is connected to the substantially central portion (central portion in the X-axis direction or its vicinity) of the cover portion 41, when the fan 3 is driven, the suction force increases toward the central side inside the cover portion 41. Accordingly, a larger amount of air flows through the flow paths on the central side (flow paths each between the energy storage device 10 and the adjacent member 2), and as a result, the energy storage devices 10 on the central side, which tend to retain heat, are effectively cooled.

The energy storage apparatus of the present invention is not limited to the above embodiment, and as a matter of course, various changes can be made without departing from the scope of the gist of the present invention. For example, the configuration of one embodiment can be added to the configuration of another embodiment, and a part of the configuration of one embodiment can be replaced with the configuration of another embodiment. In addition, a part of the configuration of one embodiment can be deleted.

In the energy storage apparatus 1 of the above embodiment, the device 3 fixed to the first adjacent member 21 is the fan, but the present invention is not limited to this configuration. For example, the device 3 may be a junction box that electrically connects and disconnects a forced circuit, an ECU, a BMS, a PCU (power control unit), a service plug (main switch) that manually and mechanically connects and disconnects the forced circuit, or the like. That is, it is only necessary that the device 3 functionally acts on the energy storage devices 10 by adjusting the temperatures of the energy storage devices 10 or electrically or manually mechanically disconnecting the forced circuit. Further, the connection component 4 is an electric wire that connects the energy storage devices 10 and a junction board when the device 3 is, for example, the junction board.

The fan (device) 3 of the above embodiment is fixed to one end portion of the first adjacent member 21 in the Z-axis direction (end portion of the energy storage device 10 opposite to the side where the external terminals 12 are arranged). However, the present invention is not limited to this configuration. For example, the fan 3 may be fixed to the other end portion of the first adjacent member 21 in the Z-axis direction or the end portion in the Y-axis direction. That is, the fan 3 may be fixed to any portion of the first adjacent member 21.

In the energy storage apparatus 1 of the above embodiment, the first adjacent member 21 to which the fan 3 is fixed is arranged at the central portion or the substantially central portion in the X-axis direction, but the present invention is not limited to this configuration. The first adjacent member 21 to which the fan 3 is fixed may be arranged at any position in the X-axis direction.

Further, in the energy storage apparatus 1 of the above embodiment, the fan 3 is fixed to one first adjacent member 21, but the present invention is not limited to this configuration. For example, the energy storage apparatus 1 may include a plurality of first adjacent members 21, and one fan 3 may be fixed to the plurality of first adjacent members 21. Further, a plurality of fans (devices) 3 may be arranged in the energy storage apparatus 1.

The first adjacent member 21 of the above embodiment is fastened (fixed) to the holding member 5, but the present invention is not limited to this configuration. The first adjacent member 21 may not be fastened (fixed) to the holding member 5.

The holding member 5 of the above embodiment includes the first extending portions 562 that directly or indirectly support the first adjacent member 21, but the present invention is not limited to this configuration. The holding member 5 may not include the first extending portions 562.

Further, in the above embodiment, the case has been described where the energy storage devices are used as non-aqueous electrolyte secondary batteries that can be charged and discharged (for example, lithium ion secondary batteries), but the type and size (capacity) of the energy storage devices are freely selectable. Further, in the above embodiment, the lithium ion secondary batteries have been described as an example of the energy storage devices, but the present invention is not limited to this. For example, the present invention can be applied to various secondary batteries, primary batteries, and energy storage devices of capacitors such as electric double layer capacitors.

What is claimed is:

1. An energy storage apparatus comprising:
a plurality of energy storage devices arranged in a first direction;
an adjacent member arranged between adjacent energy storage devices; and
a device that functionally acts on the energy storage devices,
wherein the device is fixed to the adjacent member.

2. The energy storage apparatus according to claim 1, further comprising a holding member that holds the plurality of energy storage devices and the adjacent member,
wherein the holding member includes at least one of a fastening member that fastens the adjacent member to the holding member and a support portion that supports the adjacent member.

3. The energy storage apparatus according to claim 1, wherein
each of the plurality of energy storage devices includes an external terminal projecting to one side in a second direction orthogonal to the first direction, and
the device is fixed to another side of the adjacent member in the second direction.

4. The energy storage apparatus according to claim 1, further comprising a connection component that functionally connects the plurality of energy storage devices and the device,
wherein the device is arranged at a central portion or a substantially central portion of the energy storage apparatus in the first direction.
